(19) United States
(12) Patent Application Publication
(10) Pub. No.: US 2009/0213160 A1
(43) Pub. Date: Aug. 27, 2009

(54) Printing Control System, Printing Request Terminal, Printer, and Printing Control Method

(75) Inventor: Kiyoaki MURAI, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/393,127

(22) Filed: Feb. 26, 2009

(30) Foreign Application Priority Data
Feb. 26, 2008 (JP) 2008-043935
Oct. 22, 2008 (JP) 2008-271736

(51) Int. Cl. B41J 29/38

(52) U.S. Cl. 347/14

(57) ABSTRACT

A printing control system controlling a printer performing a printing operation by ejecting a plurality of ink including specific color ink or special ink. A time interval specifying section specifies a time interval for ejecting the ink when the plurality of ink including the specific color ink or the special ink is ejected to perform the printing operation. A print data generating section generates print data for controlling the ejection of the ink every rank, which is determined as an ejection time of the ink as viewed in time series, on the basis of the time interval specified by the time interval specifying section. A printing control section allows the plurality of ink to be ejected in the time interval specified by the time interval specifying section by sequentially controlling the printer on the basis of the print data sequentially acquired from a first rank among the print data of all ranks generated by the print data generating section.

### CROSS-REFERENCE TO RELATED APPLICATIONS

This application claims the benefit of priority under 35 USC 119 of Japanese application no. 2008-043935, filed on Feb. 26, 2008, and Japanese application no. 2008-271736, filed on Oct. 22, 2008, which are incorporated herein by reference.

### BACKGROUND

1. Technical Field

The present invention relates to a system and method of controlling a printer performing a printing operation by ejecting plural ink, and more particularly, to a printing control system, a printing request terminal, a printer, and a printing control method, which are suitable for diverse expression of prints.

2. Related Art

A technique is known of assigning specific color ink to colors of pixels specified in an operating system (OS) when plural ink including specific color ink is ejected to perform a printing operation (JP-A-10-309834).

However, in the technique of JP-A-10-309834, since the specific color ink can be assigned but the time interval for ejecting ink cannot be specified, there is a problem that the expression of prints is limited.

### SUMMARY

The present invention provides a printing control system, a printing request terminal, a printer and a printing control method, which are suitable for diverse expression of prints.

According to an aspect of the invention, a printing control system controls a printer performing a printing operation by ejecting a plurality of ink including specific color ink or special ink. The printing control system includes: a time interval specifying section specifying a time interval for ejecting the ink when the plurality of ink including the specific color ink or the special ink is ejected to perform the printing operation; a print data generating section generating print data for controlling the ejection of the ink every rank, which is determined as an ejection time of the ink as viewed in time series, on the basis of the time interval specified by the time interval specifying section; and a printing control section allowing the plurality of ink to be ejected in the time interval specified by the time interval specifying section by sequentially controlling the printer on the basis of the print data sequentially acquired from a first rank among the print data of all ranks generated by the print data generating section.

According to this configuration, when the time interval is specified by the time interval specifying section, print data is generated every rank on the basis of the specified time interval by the print data generating section. The printing control section sequentially controls the printer to eject the plurality of ink at the specified time interval on the basis of the print data sequentially acquired from the first rank among the generated print data of all the ranks.

Specific color ink means ink having a color between one color of primary colors (for example, CMYK) and another color of the primary colors. Specific color ink includes, for example, ink of red, green, violet, orange, and blue when the primary colors are CMYK. The ink obtained by combining primary color ink at a certain ratio in advance to surely express a specific color is also included in specific color ink. For example, when a corporate color of a company is printed by combination of primary color ink, the corporate color is varied every printing and thus the corporate color cannot be printed in a desired color. In this case, specific color ink prepared in advance in the corporate color can be usefully used.

Special ink means ink giving texture or gloss different from primary color (for example, CMYK) ink. Special ink includes, for example, metallic color (for example, metallic, gold, and silver) ink, transparent color or white ink, fluorescent ink, pearl ink, opaque ink, magnetic ink, modulation ink modulating and reflecting light having a predetermined wavelength, glossy or glossless colorless ink, colorless transparent (for example, aqueous or oily) ink for expressing a spreading effect, and water when the primary colors are CMYK.

The printing control system may further include an ejection order specifying section specifying an order of ejecting the ink when the plurality of ink including the specific color ink or the special ink is ejected to perform the printing operation. Here, the print data generating section generates the print data for controlling the ejection of the ink every rank on the basis of the order specified by the ejection order specifying section.

According to this configuration, when the ejection order is specified by the ejection order specifying section, print data is generated every rank on the basis of the specified time interval and the specified order by the print data generating section. The printing control section sequentially controls the printer to eject the plurality of ink in the specified order on the basis of the print data sequentially acquired from the first rank among the generated print data of all the ranks.

The printing control system may further include a position changing unit changing a position of a printing medium relative to a pixel forming unit ejecting the plurality of ink to form a pixel. Here, the printing control section allows the plurality of ink to be ejected at the time interval specified by the time interval specifying section by controlling the position changing unit on the basis of the print data.

According to this configuration, the position changing unit is controlled on the basis of the print data by the printing control section. As a result, the plural ink is ejected at the specified time interval while the position of the printing medium relative to the pixel forming unit is being changed by the position changing unit.

Here, the position changing unit may stop one of the pixel forming unit and the printing medium and move the other, or may move both. The position changing unit may include, for example, a carriage or a transport roller.

In the printing control system, the primary color ink may be aqueous or oily ink and the special ink may include aqueous or oily colorless transparent ink having a characteristic corresponding to the primary color ink.

According to this configuration, the ink is mixed with each other on a printing sheet and the spreading effect can be used as an expression by controlling the expression using the spreading or the degree of spreading.

In the printing control system, the time interval specifying section may specify the time interval for ejecting the plurality of ink on the basis of drawing elements to be printed.

According to this configuration, it is possible to specify the order of ejecting the plurality of ink by specifying the time interval for printing the drawing elements to be printed.

In the printing control system, the time interval specifying section may specify the time interval for ejecting the plurality of ink on the basis of drawing layers used for printing.

According to this configuration, it is possible to specify the order of ejecting the plurality of ink by specifying the time interval for printing the drawing layers used for the printing.

According to another aspect of the invention, a printing request terminal requesting a printer for performing a printing operation is provided. The printing request terminal includes: a time interval specifying section specifying a time interval for ejecting a plurality of ink when the printer performs a printing operation by ejecting the plurality of ink including specific color ink or special ink; a print data generating section generating print data for controlling the ejection of the plurality of ink every rank, which is determined as an ejection time of the plurality of ink as viewed in time series, on the basis of the time interval specified by the time interval specifying section; and a print data transmitting section transmitting the print data generated by the print data generating section to the printer.

According to this configuration, when the time interval is specified by the time interval specifying section, the print data is generated every rank on the basis of the specified time interval by the print data generating section of the printing request terminal. The print data sequentially acquired from the first rank among the generated print data of all the ranks is sequentially transmitted to the printer by the print data transmitting section.

According to another aspect of the invention, a printer performing a printing operation by ejecting a plurality of ink including specific color ink or special ink in response to a print request from a printing request terminal is provided. The printer includes: a printing section performing the printing operation by ejecting the plurality of ink; a print data receiving section receiving print data from the printing request terminal; and a printing control section controlling the printing section to eject the plurality of ink at a predetermined time interval on the basis of the print data received by the print data receiving section. Here, the print data serves to control the ejection of the plurality of ink every rank, which is determined as an ejection time of the plurality of ink as viewed in time series, on the basis of the specification of the time interval for ejecting the plurality of ink.

According to this configuration, when the print data is received by the print data receiving section, the printing control section of the printer controls the printing section on the basis of the sequentially-received print data to eject the plurality of ink at the specified time interval.

According to another aspect of the invention, a printing control method of controlling a printer performing a printing operation by ejecting a plurality of ink including specific color ink or special ink is provided. The printing control method includes: specifying a time interval for ejecting the ink when the plurality of ink including the specific color ink or the special ink is ejected to perform the printing operation; generating print data for controlling the ejection of the ink every rank, which is determined as an ejection time of the plurality of ink as viewed in time series, on the basis of the specified time interval; and ejecting the plurality of ink at the specified time interval by sequentially controlling the printer on the basis of the print data sequentially acquired from a first rank among the generated print data of all ranks.

According to another aspect of the invention, a printing control system controlling a printer performing a printing operation by ejecting a plurality of recording materials is provided. The printing control system includes: a time interval specifying section specifying a time interval for ejecting the recording materials at the time of performing a printing operation by ejecting the plurality of recording materials; and a printing control section controlling the printer to eject the plurality of recording materials at the time interval specified by the time interval specifying section on the basis of the time interval specified by the time interval specifying section.

According to this configuration, when the time interval is specified by the time interval specifying section, the printing control section controls the printer on the basis of the specified time interval to eject the plurality of recording materials at the specified time interval.

Recording material means a material that can allow information such as characters or images to be printed on a printing medium such as a sheet of paper. Recording material includes, for example, ink and toner. An example of ink includes water causing the spreading effect, in addition to primary color (for example, CMYK) ink, specific color ink, and special ink.

When the recording materials are ejected to a single pixel three times or more, the time intervals can be specified individually or the time intervals can be specified in a bundle.

### BRIEF DESCRIPTION OF THE DRAWINGS

The invention will be described with reference to the accompanying drawings, wherein like numbers reference like elements.

FIG. 1 is a block diagram illustrating a hardware configuration of a printing system.

FIG. 2 is a block diagram functionally illustrating an example of a control process of the printing system.

FIG. 3 is a flowchart illustrating a process of specifying an ink ejecting order and an ejection time interval.

FIG. 4 is a flowchart illustrating another process of specifying the ink ejecting order and the ejection time interval.

FIG. 5 is a diagram illustrating an example of a data structure of drawing data.

FIG. 6 is a flowchart illustrating a bit map data generating process.

FIG. 7 is a flowchart illustrating a print data generating process.

FIG. 8 is a flowchart illustrating a printing control process.

FIG. 9 is a diagram illustrating a case where a rectangle is first drawn and a circle is drawn thereon in T seconds thereafter.

FIGS. 10A, 10B, and 10C are diagrams illustrating data structures of a bit map storage area and a drawing parameter storage area.

FIG. 11 is a diagram illustrating a printing order.

FIG. 12 is a diagram illustrating a printing result.

FIG. 13 is a diagram illustrating a case where a circle is first drawn and then a rectangle is drawn thereon in T seconds thereafter.

FIGS. 14A, 14B, and 14C are diagrams illustrating data structures of the bit map storage area and the drawing parameter storage area.

FIG. 15 is a diagram illustrating a printing result.

FIG. 16 is a diagram illustrating a case where the rectangle other than the circle portion is first drawn and then the circle is drawn thereon in T seconds thereafter.

FIG. 17 is a diagram illustrating a case where the circle is first drawn and then the rectangle other than the circle portion is drawn thereon in T seconds thereafter.

FIG. 18 is a diagram illustrating a printing order.

FIG. 19 is a diagram illustrating a configuration of a printer for adjusting an interval of a print head.

### DESCRIPTION OF EXEMPLARY EMBODIMENTS

### First Embodiment

A first embodiment of the invention is now described in detail with reference to the accompanying drawings.

### A. Configuration of Printing System

A configuration of a printing system to which the invention is applied is now described.

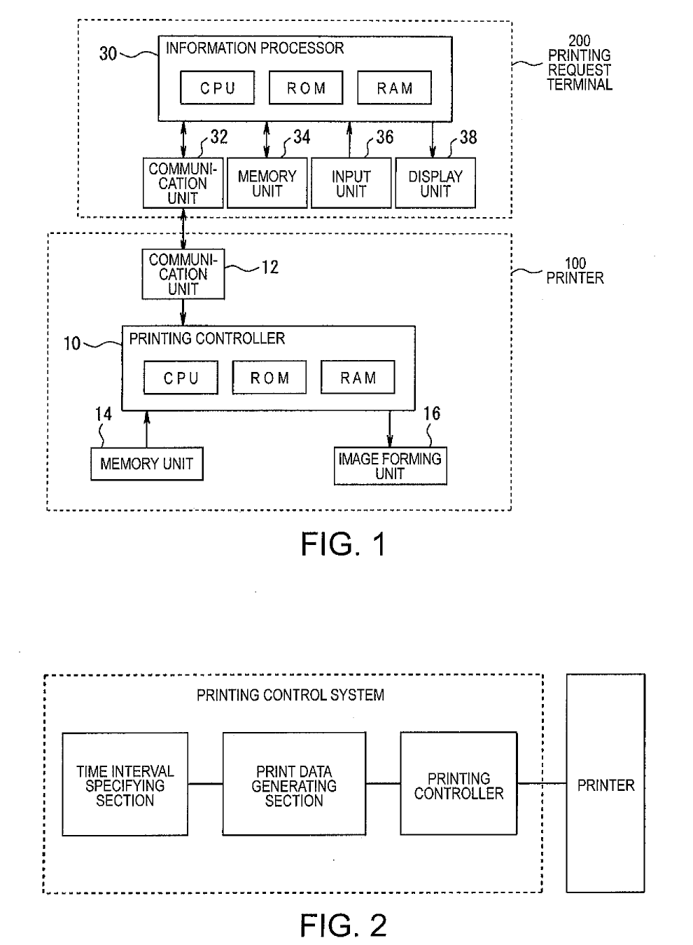

FIG. 1 is a block diagram illustrating a hardware configuration of a printing system. In FIG. 1, a printer 100 and a printing request terminal 200 requesting the printer 100 for performing a printing operation are connected to each other through a communication cable so as to communicate with each other. Here, both a serial printer and a line printer can be applied as the printer 100, but the serial printer applied as the printer will be described below.

The printer 100 includes a printing controller 10 controlling a printing operation, a communication unit 12 transmitting and receiving data to and from a printing request terminal 200, a memory unit 14 including a hard disk (HD) that can store data or tables as files, and an image forming unit 16 forming an image on a printing sheet.

The printing controller 10 includes a central processing unit (CPU) performing a computing operation and controlling the entire system on the basis of a control program, a read only memory (ROM) storing the control program and the like of the CPU in a predetermined area in advance, a random access memory (RAM) storing data read from the ROM or the computation result necessary for the computing operation of the CPU, and an interface (I/F) interfacing the input and output of data with the communication unit 12 and the like. These elements are all connected to each other through a bus, which is a signal line for transmitting data, so as to transmit and receive data.

The image forming unit 16 includes a transport roller transporting printing sheets and a carriage reciprocating in a direction perpendicular to a transport direction of the printing sheets. The carriage monolithically includes a cartridge holder to which and from which ink cartridges of primary color ink of cyan, magenta, yellow and black (CMYK), specific color ink, and special ink can be mounted and demounted, and a print head forming dots on the printing sheet by receiving the supply of ink from the cartridge holder and ejecting minute ink from nozzles. When an image is formed on a printing sheet, the printing sheet is made to move by a predetermined distance by the transport roller every reciprocation of the carriage under the control of the printing controller 10 and dots of one of the ink colors and size thereof are controlled every minimum movement in the moving direction of the print head and in the transport direction of the transport roller.

The printing request terminal 200 includes an information processor 30 processing information, a communication unit 32 transmitting and receiving data to and from the printer 100, a memory unit 34 having an HD that can store data or table as files, an input unit 36 having a keyboard or a mouse that can input data as a human interface, and a display unit 38 displaying an image on the basis of image signals.

The information processor 30 has a configuration in which a CPU, a ROM, a RAM, and an I/F are connected to each other through a bus, similar to the printing controller 10.

The memory unit 34 stores drawing data prepared by a drawing application executed by the printing request terminal 200.

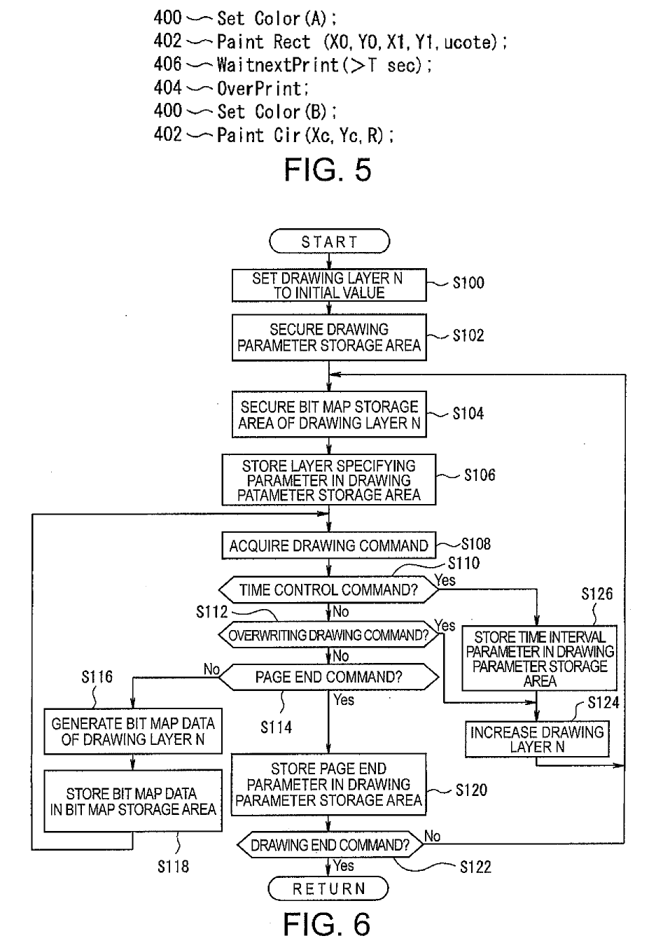

In the drawing application, for example, drawing data shown in FIG. 5 is generated by allowing an operator (user) to operate the input unit 36 while viewing a display screen on the display unit 38 as described later.

That is, in the drawing application, an ink ejecting order and a time interval for ejecting the ink can be specified by specifying at what rank the ink corresponding to a color of each drawing element such as a figure should be ejected and what time interval is set after the ejection, and the drawing data having the specified order and the specified time interval defined therein is stored in the memory unit 34.

Here, a drawing element (object) means an element based on drawing commands such as a rectangle drawing command, a circle drawing command, and an image data drawing command. The order of ejecting the ink can be specified in the unit of drawing element, or may be specified in the unit of plural drawing elements.

In the printing system to which the invention is applied and which is shown in FIG. 1, various processes or control to be described later are performed in accordance with the program stored in the ROM by the CPU of the printing controller 10 of the printer 100, or in accordance with the program stored in the ROM by the CPU of the information processor 30 of the printing request terminal 200. An example of the process or control in the printing system to which the invention is applied and which is shown in FIG. 1 can be functionally expressed as shown in FIG. 2.

The time interval specifying section of FIG. 2 corresponds to the input unit 36, the display unit 38, and the information processor 30 of the printing request terminal 200 of FIG. 1. The print data generating section of FIG. 2 corresponds to the information processor 30 of the printing request terminal 200 of FIG. 1. The printing control section of FIG. 2 corresponds to the printing controller 10 of the printer 100 of FIG. 1.

### B. Generation of Drawing Data

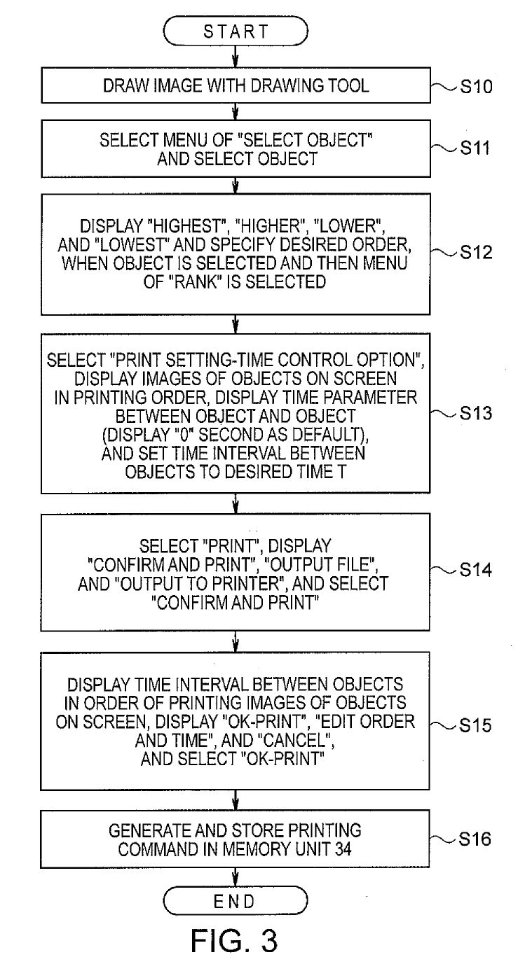

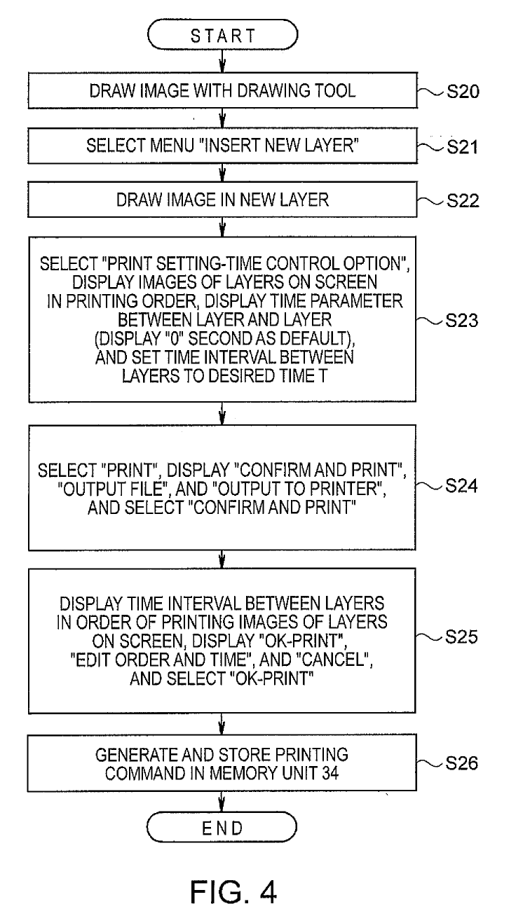

The process of specifying the ink ejecting order and the time interval to correspond to the colors of the drawing elements in the printing request terminal 200 is described with reference to FIGS. 3 and 4.

The CPU of the information processor 30 starts up a predetermined program stored in a predetermined area of the ROM and performs the processes shown in the flowcharts of FIGS. 3 and 4 in accordance with the program.

FIG. 3 shows an example where an operator draws an image and then specifies the ink ejection order and the time interval in the unit of object by the use of the input unit 36 and the display unit 38.

In this case, in step S10, the operator draws an image by the use of a drawing tool and the input unit 36 while viewing the display screen on the display unit 38. For example, color A is selected to draw a rectangle and color B is selected to draw a circle.

In step S11, a menu of “select object” is selected and an object the ink ejection order of which is specified is selected by the use of the input unit 36. For example, the circle is selected.

In step S12, when the object is selected and a menu of “rank menu” is then selected, “highest”, “higher”, “lower”, and “lowest” are displayed on the display screen. Accordingly, the operator specifies a desired rank by the use of the input unit 36. For example, “highest” is selected.

In step S13, when a “print setting-time control option” is selected, images of the objects are displayed on the display screen in the printing order. A time parameter is displayed between an object and an object (for example, “0 second” is displayed as a default) and the time interval between the objects is set to a desired time of T seconds.

In step S14, when “print” is selected, “confirm and print”, “output file”, and “print out” are displayed on the display screen. Accordingly, for example, “confirm and print” is selected by the use of the input unit 36.

In step S15, the time intervals between the objects are displayed in the order of printing the images of the objects. Then, “OK-print”, “edit order and time”, and “cancel” are displayed on the display screen. Accordingly, for example, “OK-print” is selected by the use of the input unit 36.

In step S16, a printing command (drawing command) shown in FIG. 5 is generated on the basis of the above-mentioned processes and the generated printing command is stored in the memory unit 34.

The ink ejecting order and the time interval are specified in the unit of object, but the objects (the ink ejecting order of which is specified) may be drawing layers.

FIG. 4 shows an example where an operator draws an image by drawing layers and specifies the ink ejecting order and the ejection time interval in the unit of layer by the use of the input unit 36 and the display unit 38.

In this case, in step S20, the operator draws an image by the use of the drawing tool and the input unit 36 while viewing the display screen of the display unit 38. For example, color A is selected to draw a rectangle.

In step S21, a menu of “insert new layer” is selected. Accordingly, a new layer is generated for drawing.

In step S22, an image is drawn in the new layer. For example, color B is selected to draw a circle. Here, it may be specified to use (eject) special ink (for example, water) for the entire surface of a printing target.

In step S23, when “print setting-time control option” is selected, images of the drawing layers are displayed on the display screen in the printing order. A time parameter is displayed between a drawing layer and a drawing layer (for example, “0 second” is displayed as a default) and the time interval between the layers is set to a desired time of T seconds.

In step S24, when “print” is selected, “confirm and print”, “output file”, and “print out” are displayed on the display screen. Accordingly, for example, “confirm and print” is selected by the use of the input unit 36.

In step S25, the time intervals between the drawing layers are displayed in the order of printing the images of the drawing layers on the screen. Then, “OK-print”, “edit order and time”, and “cancel” are displayed on the display screen. Accordingly, for example, “OK-print” is selected by the use of the input unit 36.

In step S26, a printing command (drawing command) shown in FIG. 5 is generated on the basis of the above-mentioned processes and the generated printing command is stored in the memory unit 34.

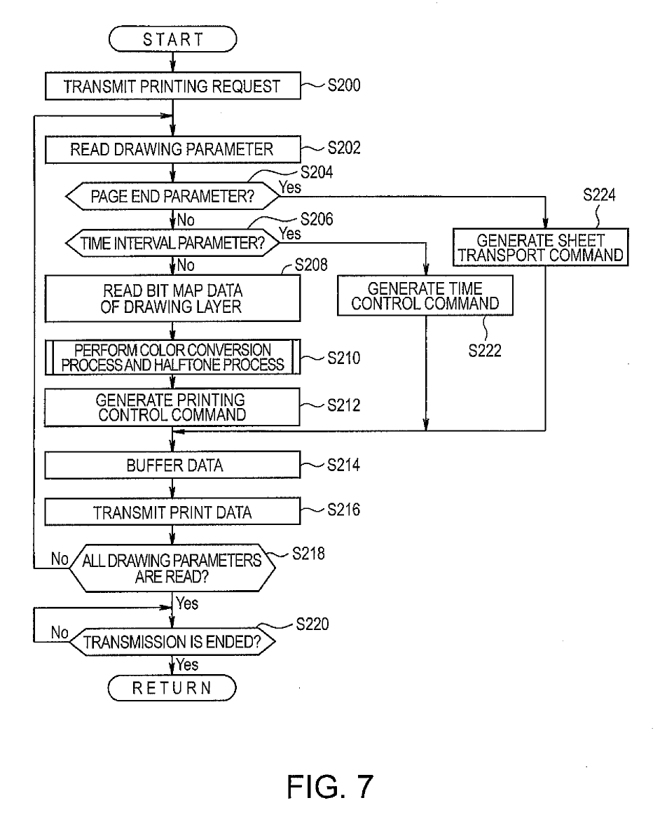

In step S16 or S26, the generated printing command is stored in the memory unit 34, but the printing command may be transmitted to the printer 100 instead. However, in this case, the bit map data generating process of FIG. 6 and the print data generating process of FIG. 7 (described later), which are based on the printing command, are carried out by the printer 100.

FIG. 5 is a diagram illustrating an example of a data structure of the drawing data.

As shown in FIG. 5, the drawing data includes a drawing command 400 for specifying colors of drawing elements, a drawing command 402 for drawing the drawing elements, a drawing command (overwriting drawing command) 404 for instructing to overwrite the drawing elements, a drawing command (time control command) 406 for specifying the time interval for ejecting the ink, a drawing command (not shown) for instructing a drawing end of a page, and a drawing command (not shown) for instructing a drawing end of all images. In the example of FIG. 5, a rectangle specified by coordinates (X0,Y0,X1,Y1) is drawn with color A and a circle specified by coordinates (Xc,Yc,R) is overwritten thereon with color B in the time interval of T seconds. In this case, ink corresponding to color A (ink A) is ejected to the portion where the rectangle of color A and the circle of color B overlap with each other and then ink corresponding to color B (ink B) is ejected thereon in the time interval of T seconds.

### C. Processes of Printing Request Terminal

Processes performed by the printing request terminal 200 are now described now.

The CPU of the information processor 30 includes a micro processing unit or the like, starts up a predetermined program stored in a predetermined area of the ROM, and performs the bit map data generating process and the print data generating process shown in the flowcharts of FIGS. 6 and 7 in accordance with the program.

### C-1. Bit Map Data Generating Process

The bit map data generating process is now described. FIG. 6 is a flowchart illustrating the bit map data generating process.

When the bit map data generating process is performed by the CPU of the information processor 30, as shown in FIG. 6, the process of step S100 is first performed. In step S100, a drawing layer N as a variable is set to “1” as an initial value.

In this embodiment, since an image is divided into plural layers and then printed, one of the plural layers is the drawing layer. Accordingly, a drawing layer means a layer in which the drawing elements to be printed at a time are grouped. The drawing elements can be overlapped and printed by arranging the drawing elements, the coordinates of which overlap with each other, in the plural drawing layers. Therefore, the ink ejecting order can be changed in the overlapping portion of the drawing elements, depending on the drawing layers and the drawing elements disposed in the drawing layers.

A drawing parameter storage area is secured in the RAM in step S102 and a bit map storage area storing bit map data of the drawing layer N is secured in the RAM in step S104. Then, the process of step S106 is performed.

In step S106, the drawing parameter (layer specifying parameter) indicating the drawing layer N is stored in the drawing parameter storage area. Then, a drawing command is acquired from the drawing data stored in the memory unit 34 in step S108, and the process of step S110 is then performed.

In step S110, it is determined whether the acquired drawing command is the drawing command (time control command) for specifying the time interval for ejecting the ink (see FIG. 5). When it is determined that the acquired drawing command is not the time control command (No), the process of step S112 is performed.

In step S112, it is determined whether the acquired drawing command is the drawing command (overwriting drawing command) instructing to overwrite the drawing element (see FIG. 5). When it is determined that the acquired drawing command is not the overwriting drawing command (NO), the process of step S114 is performed.

In step S114, it is determined whether the acquired drawing command is the drawing command (page end command) instructing to end the drawing. When it is determined that the acquired drawing command is not the page end command (NO), the process of step S116 is performed.

The bit map data of the drawing layer N is generated on the basis of the acquired drawing command in step S116, the generated bit map data is stored in the bit map storage area in step S118, and then the process of step S108 is performed.

On the other hand, when it is determined in step S114 that the acquired drawing command is the page end command (YES), the process of step S120 is performed. That is, the drawing parameter (page end parameter) indicating the drawing end of the page is stored in the drawing parameter storage area and the process of step S122 is performed.

In step S122, it is determined whether the acquired drawing command is the drawing command (drawing end command) indicating the drawing end of all. When it is determined that the acquired drawing command is the drawing end command (YES), the series of processes is ended, and the original process is performed again. Otherwise (NO), the process of step S104 is performed.

On the other hand, when it is determined in step S112 that the acquired drawing command is the overwriting drawing command (YES), “1” is added to the drawing layer N in step S124 and then the process of step S104 is performed.

When it is determined in step S110 that the acquired drawing command is the time control command (YES), the drawing parameter (time interval parameter) indicating the time interval specified by the acquired time control command is stored in the drawing parameter storage area in step S126 and then the process of step S124 is performed.

### C-2. Print Data Generating Process

The print data generating process is now described. FIG. 7 is a flowchart illustrating the print data generating process.

The print data generating process is performed subsequently to the bit map data generating process. When the process is performed by the CPU of the information processor 30, the process of step S200 is first performed as shown in FIG. 7.

A printing request is transmitted to the printer 100 through the communication unit 32 in step S200, the drawing parameter is read from the drawing parameter storage area in step S202, and then the process of step S204 is performed.

In step S204, it is determined whether the read drawing parameter is the page end parameter. When it is determined that the read drawing parameter is not the page end parameter (NO), the process of step S206 is performed.

In step S206, it is determined whether the read drawing parameter is the time interval parameter. When it is determined that the read drawing parameter is not the time interval parameter (NO), the read drawing parameter is determined as being the layer specifying parameter by the erasing method and then the process of step S208 is performed.

In step S208, the bit map data of the drawing layer (specified drawing layer) specified by the read layer specifying parameter is read from the bit map storage area and then the process of step S210 is performed.

In step S210, a color conversion process and a halftone process are performed on the read bit map data to generate binary data. Binary data is data indicating a printing image in which plural pixels are arranged in the horizontal direction and the vertical direction to correspond to the moving direction of the print head and the transport direction of the transport roller, and is data indicating that a dot is not formed in the respective pixels or indicating one of the ink colors and the dot size when the dots are formed.

Then, in step S212, a printing control command is generated on the basis of the generated binary data. The printing control command is a command for controlling the printer 100 to form an image of the specified drawing layer. Examples thereof include a color setting command for setting a color of a pixel, a position control command for controlling the position of the print head or the printing sheet, a printing command for ejecting ink, a sheet transport command for discharging the printing sheet, and a time control command for waiting for the printing operation for the specified time interval.

The generated printing control command is buffered as the print data in the memory unit 34 in step S214, the print data buffered in the memory unit 34 is transmitted to the printer 100 through the communication unit 32 in step S216, and then the process of step S218 is performed.

In step S218, it is determined whether all the drawing parameters are read from the drawing parameter storage area. When it is determined that all the drawing parameters are read (YES), the process of step S220 is performed. Otherwise (NO), the process of step S202 is performed.

It is determined in step S220 whether the transmission of the printing control command is ended. When it is determined that the transmission is ended (YES), the series of processes is ended and the original process is performed again. Otherwise (NO), the process of step S220 is waited for until the transmission is ended.

On the other hand, when it is determined in step S206 that the read drawing parameter is the time interval parameter (YES), the time control command for waiting for the printing operation for the time interval specified by the read time interval parameter is generated in step S222 and then the process of step S214 is performed.

On the other hand, when it is determined in step S204 that the read drawing parameter is the page end parameter (YES), the sheet transport command is generated in step S224 and then the process of S214 is performed.

### D. Processes of Printer

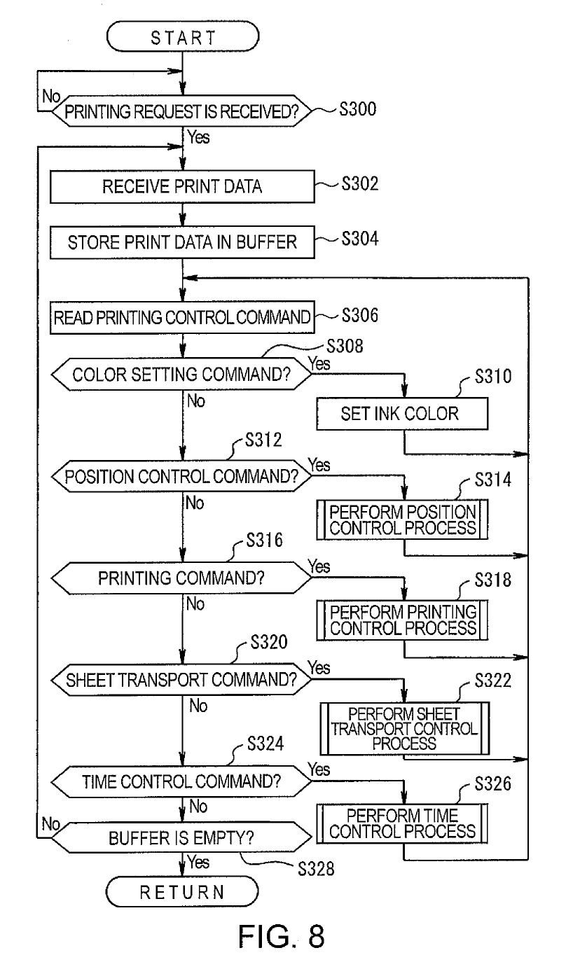

The processes performed by the printer 100 are now described now. FIG. 8 is a flowchart illustrating the printing control process.

The CPU of the printing controller 10 includes a micro processing unit or the like, starts up a predetermined program stored in a predetermined area of the ROM, and performs the printing control process shown in the flowchart of FIG. 8 in accordance with the program.

when the printing control process is performed by the CPU of the printing controller 10, the process of step S300 is first performed as shown in FIG. 8.

In step S300, it is determined whether the printing request is received through the communication unit 12. When it is determined that the printing request is received (YES), the process of step S302 is performed. Otherwise (NO), the process of step S300 is waited for until the printing request is received.

The print data is received through the communication unit 12 in step S302, the received print data is stored in a buffer of the memory unit 14 in step S304, and then the process of step S306 is performed.

The printing control command is read from the buffer in step S306 and it is then determined in step S308 whether the read printing control command is the color setting command. When the read printing control command is the color setting command (YES), the process of step S310 is performed.

In step S310, the ink color is set on the basis of the read printing control command, and then the process of step S306 is performed.

On the other hand, when it is determined in step S308 that the read printing control command is not the color setting command (NO), it is determined in step S312 whether the read printing control command is the position control command. When it is determined that the read printing control command is the position control command (YES), the process of step S314 is performed.

In step S314, the position control process of controlling the position of the print head or the printing sheet is performed by controlling the carriage or the transport roller on the basis of the read printing control command and then the process of step S306 is performed. The position control process includes skipping a portion not having any printing image, returning a position point to the original position as an initial value, and controlling a position to obtain an effect substantially equivalent to the sheet transport with the movement of the carriage.

On the other hand, when it is determined in step S312 that the read printing control command is not the position control command (NO), it is determined in step S316 whether the read printing control command is the printing command. When it is determined that the read printing control command is the printing command (YES), the process of step S318 is performed.

In step S318, the printing control process of ejecting ink of the ink color set in step S310 is performed by controlling the print head on the basis of the read printing control command and then the process of step S306 is performed.

On the other hand, when it is determined in step S316 that the read printing control command is not the printing command (NO), it is determined in step S320 whether the read printing control command is the sheet transport command. When it is determined that the read printing control command is the sheet transport command (YES), the process of step S322 is performed.

In step S322, the sheet transport control process of discharging a printing sheet is performed by controlling the transport roller on the basis of the read printing control command and then the process of step S306 is performed.

On the other hand, when it is determined in step S320 that the read printing control command is not the sheet transport command (NO), it is determined in step S324 whether the read printing control command is the time control command. When it is determined that the read printing control command is the time control command (YES), the process of step S326 is performed.

In step S326, the waiting process of waiting for the printing operation for the time interval specified by the read time control command is performed, and then the process of step S306 is performed.

On the other hand, when it is determined in step S324 that the read printing control command is not the time control command (NO), it is determined in step S328 whether the buffer is empty. When it is determined that the buffer is empty (YES), the series of processes is ended and the original process is performed again.

On the other hand, when it is determined in step S328 that the buffer is not empty (NO), the process of step S302 is performed.

### E. Printing Operation

A printing operation of this embodiment is now described.

FIG. 9 is a diagram illustrating a case where a rectangle is first drawn and then a circle is drawn thereon in the time interval of T seconds. In this embodiment, as shown in FIG. 9, the rectangle is drawn with color A and the circle is overwritten and drawn thereon with color B in the time interval of T seconds.

When the drawing data shown in FIG. 5 is prepared in the printing request terminal 200, the bit map data of each drawing layer is generated through steps S100 to S128 by the information processor 30, the bit map data is stored in the bit map storage area, and the necessary drawing parameter is stored in the drawing parameter storage area.

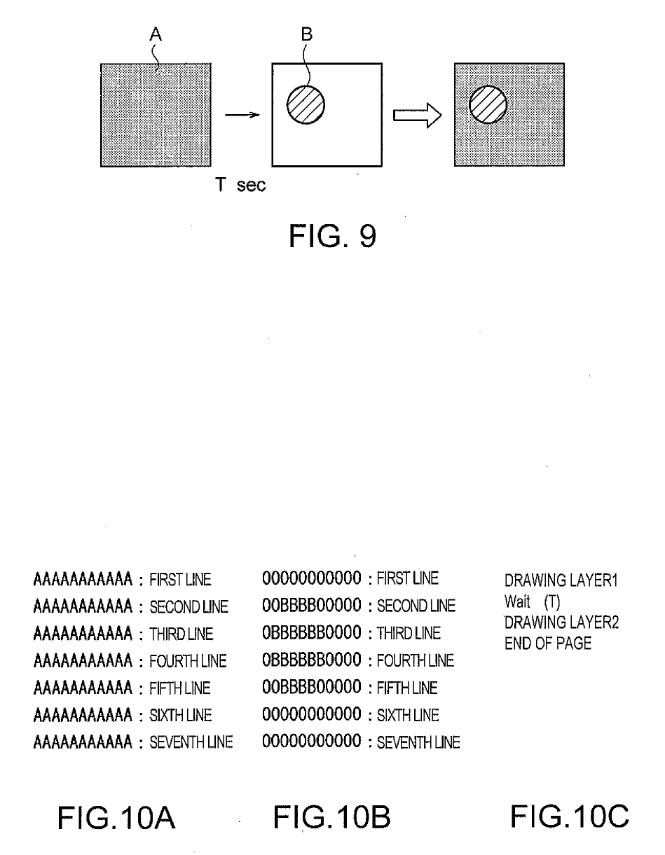

FIGS. 10A to 10C are diagrams illustrating data structures of the bit map storage area and the drawing parameter storage area.

Color information “A” for the respective pixels of the rectangle is stored in the bit map storage area of drawing layer 1 as shown in FIG. 10A, and color information “B” of the respective pixels of the circle is stored in the bit map storage area of drawing layer 2 as shown in FIG. 10B. Color information “0” means that no pixel is formed. As shown in FIG. 10C, the layer specifying parameter “drawing layer 1”, the time control parameter “wait (T)”, the layer specifying parameter “drawing layer 2”, and the page end parameter are stored in the drawing parameter storage area.

In the printing request terminal 200, the print data is generated every drawing layer through steps S200 to S224 by the information processor 30 and the generated print data is sequentially transmitted to the printer 100.

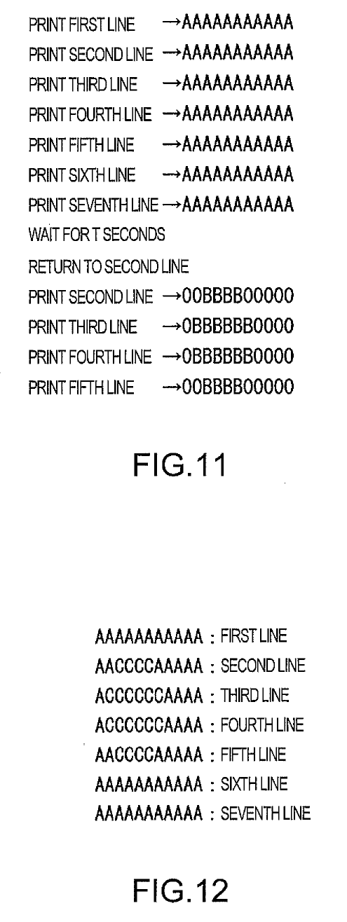

FIG. 11 is a diagram illustrating a printing order. When the printer 100 receives the print data, the printing controller 10 controls the image forming unit 16 on the basis of the sequentially received print data through steps S300 to S328. As a result, as shown in FIG. 8, the rectangular image is formed from the first line to the seventh line with ink A, the printing sheet is returned to the second line, and the circular image is formed from the second line to the fifth line with ink B.

FIG. 12 is a diagram illustrating the printing result. In the printing result, since ink A is first ejected to the portion in which the rectangle and the circle overlap with each other and then ink B is ejected thereon in the time interval of T seconds as shown in FIG. 12, color C having an expression based on the specified order and the specified time interval is obtained.

### F. Ejection Time Interval

The inventor discovered, as a result of hard study, that the expression of prints varies depending on the time interval for ejecting ink when plural ink is ejected to perform a printing operation. For example, the texture of prints varies between the case where specific color ink A is first ejected and ink B is ejected just thereafter and the case where specific color ink A is first ejected and ink B is then ejected thereon in a predetermined time interval thereafter. It is thought that this phenomenon similarly occurs when special ink is ejected. Various methods are described below.

Aqueous CMYK ink is used as the primary color ink and water ink (water) is used as the special ink. Matted paper or Japanese paper is used as the printing sheet.

In method 1, the special ink is first ejected on the front surface or the periphery including an area having an image and then the primary color ink is ejected thereon in T1 seconds (which is a time sufficient to soak the water into the printing sheet) thereafter. Accordingly, the water and the aqueous ink are mixed on the printing sheet to express the spreading effect, thereby embodying a new expression.

In method 2, the special ink is first ejected on the front surface or the periphery including an area having an image and then the primary color ink is ejected thereon in T2 seconds (T2>T1) thereafter. By setting the time interval to be different from method 1, the spreading effect can be controlled to express a spreading effect different from method 1, thereby embodying a new expression.

In method 3, the primary color ink is ejected and the special ink is ejected on the front surface or the periphery including an area having an image in T3 seconds (time sufficient for spreading the primary color ink in the printing sheet) thereafter. This is a pattern having an ink ejecting order opposite to methods 1 and 2. Since the method of spreading the ink in the printing sheet is different from the first ejected ink, a spreading effect different from methods 1 and 2 can be expressed, thereby embodying a new expression. By changing the time interval, the expression can be widened.

In method 4, non-quick-drying metallic ink is used instead of the special ink. Ink jet photographic paper or printing paper used for pamphlets is used as the printing sheet. In a combination of the non-quick-drying metallic ink with the printing sheet, the spreading does not cause any problems even when color ink is ejected thereon or the periphery thereof in N seconds thereafter. In addition, an object can be printed in the vicinity of the metallic object. However, when the primary color ink is ejected to the vicinity thereof within N seconds, it is spread with the primary ink to cause turbidity, thereby causing a print having an expression not meeting the expectation. Ideally, the desired texture may be obtained with the quick-drying metallic ink. However, non-quick-drying metallic ink can be preferably used, as long as the desired texture can be obtained with any particular ink.

In method 5, the special ink is ejected as a metallic layer and the primary color ink is ejected thereon in N seconds thereafter. By setting the time interval of N seconds in this way, the non-quick-drying metallic ink can be first used, thereby embodying the desired expression.

In this way, in this embodiment, by specifying the time interval for ejecting ink and ejecting plural ink at the specified time interval to form a single pixel, a case of first ejecting ink A and then ejecting ink B thereon and a case of ejecting ink B with a different time interval interposed therebetween can be embodied, thereby accomplishing a more diverse expression of prints.

In this way, in this embodiment, by specifying the ink ejecting order and ejecting plural ink in the specified order to form a single pixel, a case of first ejecting ink A and then ejecting ink B thereon and a case of ejecting the ink in the opposite order can be embodied, thereby further accomplishing a diverse expression of prints.

In this embodiment, it is possible to control the spreading effect with another ink by using water ink as the special ink.

### Second Embodiment

A second embodiment of the invention is now described.

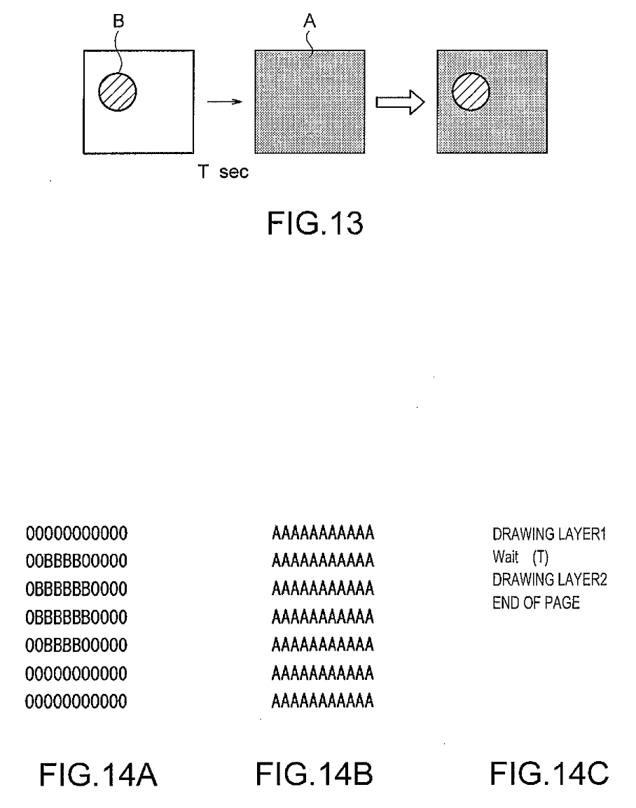

FIG. 13 is a diagram illustrating a case where the circle is first drawn and then the rectangle is drawn thereon in T seconds thereafter. In this embodiment, as shown in FIG. 13, the circle is drawn with color B and then the rectangle is overwritten and drawn thereon with color A in T seconds thereafter.

When the drawing data shown in FIG. 5 is prepared in the printing request terminal 200, the bit map data is generated every drawing layer, the bit map data is stored in the bit map storage area and the necessary drawing parameters are stored in the drawing parameter storage area.

FIGS. 14A, 14B, and 14C are diagrams illustrating data structures of the bit map storage area and the drawing parameter storage area.

Color information “B” for the respective pixels of the circle is stored in the bit map storage area of drawing layer 1 as shown in FIG. 14A and color information “A” of the respective pixels of the rectangle is stored in the bit map storage area of drawing layer 2 as shown in FIG. 14B. The same drawing parameter as shown in FIG. 10C is stored in the drawing parameter storage area as shown in FIG. 14C.

In the printing request terminal 200, the print data is generated every drawing layer and the print data is sequentially transmitted to the printer 100.

When the printer 100 receives the print data, the image forming unit 16 is controlled on the basis of the sequentially received print data to obtain the prints.

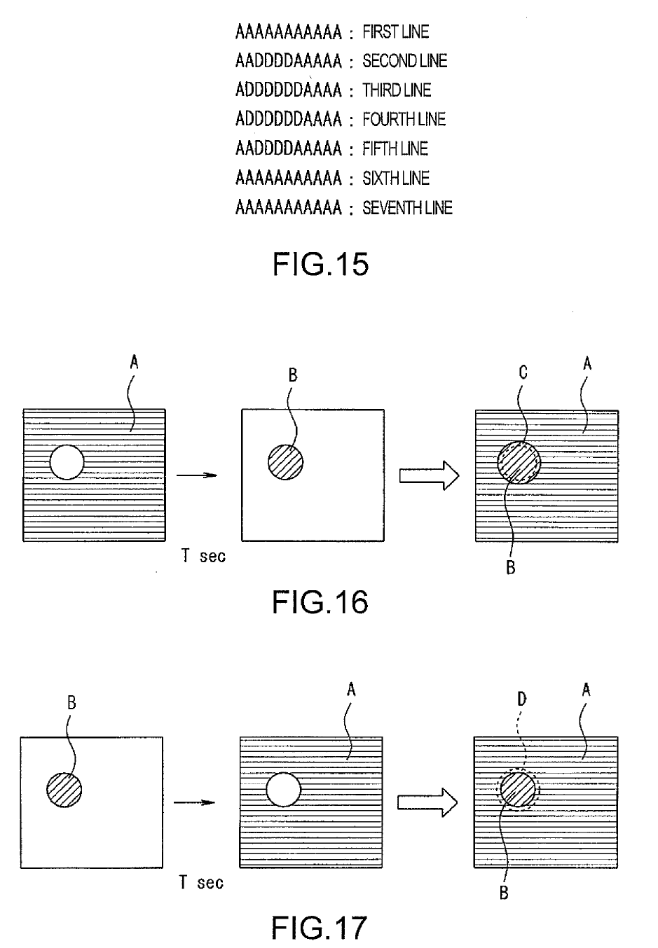

FIG. 15 is a diagram illustrating the printing result. In the printing result, since ink B is first ejected to the portion in which the rectangle and the circle overlap with each other and then ink A is ejected thereon in T seconds thereafter as shown in FIG. 15, color D having an expression based on the specified order and the specified time interval can be obtained.

### Other Embodiments

The following modified examples can be considered in addition to the first and second embodiments.

(1) FIG. 16 is a diagram illustrating a case where a rectangle other than a circle portion is first drawn and a circle is drawn thereon in T seconds thereafter. In this case, color C is obtained in the boundary of the rectangle and the circle.

(2) FIG. 17 is a diagram illustrating a case where a circle is first drawn and then a rectangle other than the circle portion is drawn thereon in T seconds. In this case, color D is obtained in the boundary of the rectangle and the circle.

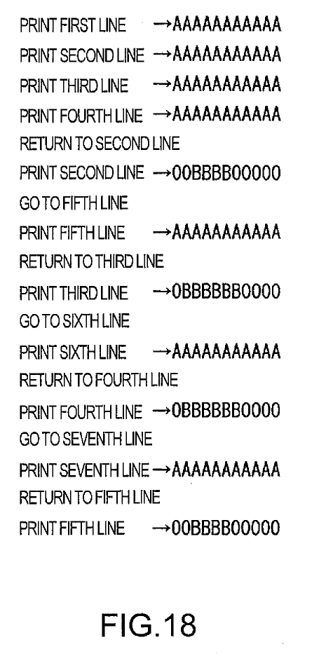

(3) FIG. 18 is a diagram illustrating a printing order. As shown in FIG. 18, the rectangular image may be formed with ink A at the same time as forming the circular image with ink B. In the example of FIG. 18, the time for returning the printing sheet by two lines after printing two lines is T seconds. Accordingly, the printing sheet need not be returned greatly, thereby improving the precision of the printing position, which causes a problem due to an error between the sheet transport and the sheet returning. This is effective when the length of the printing sheet varies due to the first printing operation. In addition, when the size of image is changed, the time interval is not excessively elongated for the same image. Accordingly, it is effective when it is intended to control the expression actively using the spreading effect of ink.

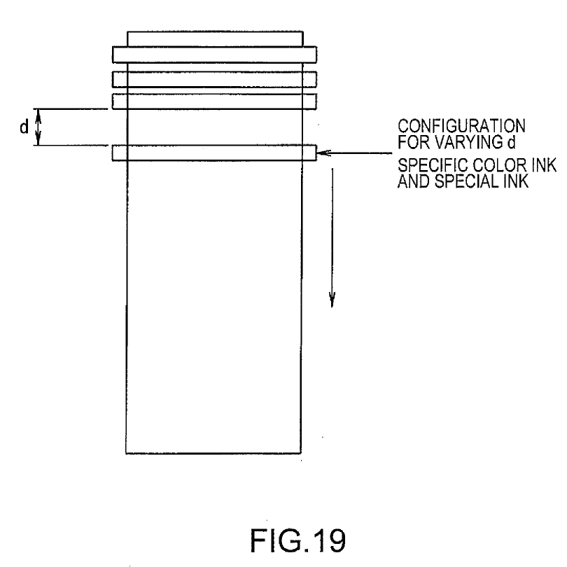

(4) FIG. 19 is a diagram illustrating a configuration of a printer for adjusting an interval of a print head. As shown in FIG. 19, the positions of the print heads of respective colors may be set to be physically different from each other, thereby not causing any problem with the mechanical movement time.

(5) It is effective that one of the positional relation of the print heads and the transport speed of the printing sheet (sheet transporting speed) is variable depending on the time interval. Accordingly, the problem with printing precision due to an error between sheet transport and sheet returning is solved to improve safety. In addition, sheet transporting is simplified, thereby improving printing speed.

(6) Although the time interval for ejecting ink has been specified by an application, the invention is not limited to this configuration, and the ink ejecting order may be specified by the OS or the device driver. The invention does not limit the functions or relations of the application, the OS, and the device driver.

(7) The invention may be applied to printing on metal or cloth, as well as a printing sheet. The invention is effective in the field of ink jet applications such as forming wirings or objects by ink jet.

(8) Only the time interval may be specified without specifying the ink ejecting order.

(9) Colorless transparent oily ink may be used as the special ink. Even in this case, the spreading effect with another ink can be controlled similarly.

(10) Although a printer has been exemplified in which a print head ejecting ink onto a printing sheet reciprocates in a direction perpendicular to the transport direction of the printing sheet, the invention may be applied to a line head printer in which plural print heads are arranged in a direction perpendicular to the transport direction of the printing sheet and a printing operation is performed without moving the print heads.

(11) When the time interval for ejecting the ink is specified, it has been described that a predetermined time interval is specified and the ink is ejected at the predetermined time interval. However, the invention is not limited to this configuration, and may be configured to eject the ink at a time interval at least equal to or greater than the specified time interval. For example, when the specified time interval is 2 seconds, the ink may be ejected at a time interval of 5 seconds.

What is claimed is:

1. A printing control system controlling a printer performing a printing operation by ejecting a plurality of ink including specific color ink or special ink, the printing control system comprising:
a time interval specifying section specifying a time interval for ejecting the ink when the plurality of ink including the specific color ink or the special ink is ejected to perform the printing operation;
a print data generating section generating print data for controlling the ejection of the ink every rank, which is determined as an ejection time of the ink as viewed in time series, on the basis of the time interval specified by the time interval specifying section; and
a printing control section allowing the plurality of ink to be ejected in the time interval specified by the time interval specifying section by sequentially controlling the printer on the basis of the print data sequentially acquired from a first rank among the print data of all ranks generated by the print data generating section,
wherein the time interval specifying section specifies the time interval based on input by a user.

2. The printing control system according to claim 1, further comprising an ejection order specifying section specifying an order of ejecting the ink when the plurality of ink including the specific color ink or the special ink is ejected to perform the printing operation,
wherein the print data generating section generates the print data for controlling the ejection of the ink every rank on the basis of the order specified by the ejection order specifying section.

3. The printing control system according to claim 1, further comprising a position changing unit changing a position of a printing medium relative to a pixel forming unit ejecting the plurality of ink to form a pixel,
wherein the printing control section allows the plurality of ink to be ejected at the time interval specified by the time interval specifying section by controlling the position changing unit on the basis of the print data.

4. The printing control system according to claim 1, wherein the primary color ink is aqueous or oily ink and the special ink includes aqueous or oily colorless transparent ink having a characteristic corresponding to the primary color ink.

5. The printing control system according to claim 1, wherein the time interval specifying section specifies the time interval for ejecting the plurality of ink on the basis of drawing elements to be printed.

6. The printing control system according to claim 1, wherein the time interval specifying section specifies the time interval for ejecting the plurality of ink on the basis of drawing layers used for printing.

7. A printing request terminal requesting a printer for performing a printing operation, the printing request terminal comprising:
a time interval specifying section specifying a time interval for ejecting a plurality of ink when the printer performs a printing operation by ejecting the plurality of ink including specific color ink or special ink;
a print data generating section generating print data for controlling the ejection of the plurality of ink every rank, which is determined as an ejection time of the plurality of ink as viewed in time series, on the basis of the time interval specified by the time interval specifying section; and
a print data transmitting section transmitting the print data generated by the print data generating section to the printer,
wherein the time interval specifying section specifies the time interval based on input by a user.

8. A printer performing a printing operation by ejecting a plurality of ink including specific color ink or special ink in response to a print request from a printing request terminal, the printer comprising:
a printing section performing the printing operation by ejecting the plurality of ink;
a print data receiving section receiving print data from the printing request terminal; and
a printing control section controlling the printing section to eject the plurality of ink at a predetermined time interval on the basis of the print data received by the print data receiving section,
wherein the print data serves to control the ejection of the plurality of ink every rank, which is determined as an ejection time of the plurality of ink as viewed in time series, on the basis of a specification of the time interval for ejecting the plurality of ink,
wherein the printing control section specifies the time interval based on input by a user.

9. A printing control method of controlling a printer performing a printing operation by ejecting a plurality of ink including specific color ink or special ink, the printing control method comprising:
specifying a time interval for ejecting the ink when the plurality of ink including the specific color ink or the special ink is ejected to perform the printing operation;
generating print data for controlling the ejection of the ink every rank, which is determined as an ejection time of the plurality of ink as viewed in time series, on the basis of the specified time interval; and
ejecting the plurality of ink at the specified time interval by sequentially controlling the printer on the basis of the print data sequentially acquired from a first rank among the generated print data of all ranks,
wherein the time interval is specified based on input by a user.

10. A printing control system controlling a printer performing a printing operation by ejecting a plurality of recording materials, the printing control system comprising:
a time interval specifying section specifying a time interval for ejecting the recording materials at the time of performing a printing operation by ejecting the plurality of recording materials; and
a printing control section controlling the printer to eject the plurality of recording materials at the time interval specified by the time interval specifying section on the basis of the time interval specified by the time interval specifying section,
wherein the time interval specifying section specifies the time interval based on input by a user.
